(19) United States
(12) Patent Application Publication
(10) Pub. No.: US 2005/0198194 A1
(43) Pub. Date: Sep. 8, 2005

(54) Method, apparatus and program storage device for providing wireless storage

(75) Inventor: Todd R. Burkey, Savage, MN (US)

Correspondence Address: CRAWFORD MAUNU PLLC, 1270 NORTHLAND DRIVE, SUITE 390, ST. PAUL, MN, 55120, US

(73) Assignee: XIOtech Corporation

(21) Appl. No.: 10/781,074

(22) Filed: Feb. 18, 2004

(51) Int. Cl. G06F 15/16; G06F 15/173

(52) U.S. Cl. 709/217; 709/225

(57) ABSTRACT

A method, apparatus and program storage device for providing wireless storage is disclosed. At least a first wireless storage node and at least one network node are provided. A plurality of wireless channels couple the first wireless storage node and the network node. The plurality of the wireless channels for the first wireless storage node are assigned based upon loading.

### BACKGROUND OF THE INVENTION

1. Field of the Invention

This invention relates in general to storage systems, and more particularly to a method, apparatus and program storage device for providing wireless storage.

2. Description of Related Art

As computer systems have evolved so has the availability and configuration of data storage devices, such as magnetic or optical disks. For example, these storage devices can be connected to the computer system via a bus, or they can be connected to the computer system via a wired or wireless network. In addition, the storage devices can be separate or co-located in a single cabinet.

As the amount of storage increases, and the number of file servers in communication networks grows, the concept of a storage area network (SAN) has arisen. Storage area networks connect a number of mass storage systems in a communication network, which is optimized for storage transactions. Thus, a storage network provides a collection of interconnected computing systems, referred to as nodes, operating as a single storage resource. A storage network allows a system to continue to operate during hardware or software failures, increases scalability by allowing nodes to be easily added and simplifies management by allowing an administrator to manage the nodes as a single system.

In a SAN, file servers and other users of the storage systems are configured to communicate with specific storage media via a network. For example, fiber channel arbitrated loop FC-AL networks are being implemented as SANs. The SANs support many point-to-point communication sessions between users of the storage systems and the specific storage systems on the SAN.

As with almost any network, there is always the need to reduce the complexity of wiring in today's constantly growing storage market, both from a load balancing and a connectivity point of view. Also, the desire to wire in new storage and storage appliances is gaining momentum. Coupled with these storage developments, there has been an increasing need for mobile computing in recent years. Mobile computing performs information processing by connecting to an existing Internet service network through a mobile-phone circuit, for example. As third-generation (3G) networks gain greater penetration, wireless connectivity will fuel growth in the burgeoning storage market by enabling new applications for database access and content sharing. Moreover, wireless storage technology could blossom on a more significant scale to change the way businesses share information and do business with customers.

Wireless applications for storage area networks include digital photography, location-based services, customer relationship management as well as unified messaging, voice information, and telematics. Wireless applications for storage area networks would also allow mission-critical customer service, business planning, and workflow automation applications to benefit from anytime, anywhere information collection and distribution. For example, improved products and more responsive customer service would be facilitated if field service, sales force and manufacturing personnel were connected in real-time to central repositories of information.

In addition, as the businesses and consumers increasingly go wireless, the concept of data storage on the go evolves to networks that let users store, retrieve and share just about anything from personal music collections to important client information and lifesaving data in emergencies. Online SAN technology could also transform the way entertainment is delivered.

These trends would represent an advance from what is already being seen in enterprise storage. For example, large corporations have deployed wired storage area networks (SANs) to provide access to a single database, often through web servers. The goal of a SAN is to integrate different types of storage subsystems such as high-throughput RAID, high-transaction rate RAID, near-line long-term archival storage, and short-term backup storage into a single system. Many firms also use network-attached storage (NAS), consisting of peripheral devices or systems dedicated to providing shared internal storage space. However, with wireless SANs, combined with an increasing array of mobile devices able to access them, the scope and possible uses of wireless storage networks could increase dramatically.

Finally, storage devices themselves are going beyond the traditional single and dual controller models to N-way controllers (i.e., N being 3 or more) managing a number of local and geographically distributed disk drives. This further complicates the writing busses, load balancing and the system robustness, all of which can be improved via a wireless approach.

It can be seen then that there is a need for a method, apparatus and program storage device for providing wireless storage.

### SUMMARY OF THE INVENTION

To overcome the limitations in the prior art described above, and to overcome other limitations that will become apparent upon reading and understanding the present specification, the present invention discloses a method, apparatus and program storage device for providing wireless storage.

The present invention solves the above-described problems by providing a manageable wireless network that allows load balancing between nodes.

A system in accordance with the principles of the present invention includes a first wireless storage node, a network node and a plurality of wireless channels coupling the first wireless storage node and the network node, an assignment of the plurality of the wireless channels of the first wireless storage node being based upon loading.

In another embodiment of the present invention, a method for providing wireless storage is provided. The method includes assigning a first set of wireless channels to a first wireless storage node, assigning a second set of wireless channels to a wireless network node, monitoring a loading between the wireless network node and at least the first wireless storage node and modifying the assignment of wireless channels when the loading between the wireless network node and at least the first wireless storage node changes.

In another embodiment of the present invention, another wireless storage network is provided. This wireless storage network includes a plurality of wireless storage devices having at least one wireless interface each and a plurality of wireless channels, the wireless channels being assigned to the wireless interfaces of the plurality of wireless storage devices, wherein the load to the plurality of wireless storage devices is balanced by adjusting assignments of the plurality of wireless channels to the plurality of wireless storage devices.

In another embodiment of the present invention, a program storage device readable by a computer tangibly embodying one or more programs of instructions executable by the computer to perform a method for providing wireless storage is provided. The method includes assigning a first set of wireless channels to a first wireless storage node, assigning a second set of wireless channels to a wireless network node, monitoring a loading between the wireless network node and at least the first wireless storage node and modifying the assignment of wireless channels when the loading between the wireless network node and at least the first wireless storage node changes.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a storage area network;

FIG. 2 shows wireless nodes in a wireless storage network according to the present invention;

FIG. 3 shows a wireless storage network according to an embodiment of the present invention;

FIG. 4 is a flow chart of the method for providing wireless storage according to an embodiment of the present invention; and

FIG. 5 illustrates a wireless storage node 500 according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for providing wireless storage. The present invention provides a manageable wireless network for a storage area network that allows load balancing between nodes.

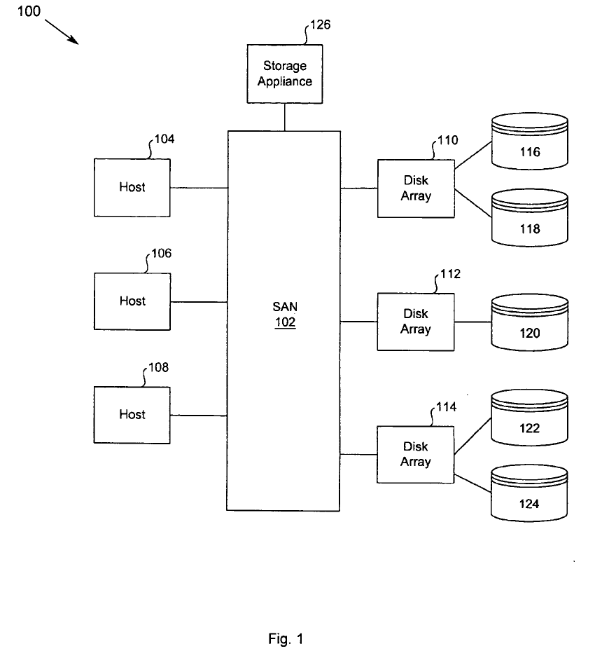

FIG. 1 illustrates a storage area network 100. A storage-area network is a high-speed network for interconnecting different kinds of storage devices such as tape libraries and disk arrays. These devices can be shared by all users (regardless of location or operating systems) through network servers. In FIG. 1, a storage area network 102 provides a set of hosts (e.g., servers or workstations) 104, 106, 108 that may be coupled to a pool of storage devices (e.g., disks). In SCSI parlance, the hosts may be viewed as “initiators” and the storage devices may be viewed as “targets.” A storage pool may be implemented, for example, through a set of storage arrays or disk arrays 110, 112, 114. Each disk array 110, 112, 114 further correspond to a set of disks. In this example, first disk array 110 corresponds to disks 116, 118, second disk array 112 corresponds to disk 120, and third disk array 114 corresponds to disks 122, 124. Rather than enabling all hosts 104-108 to access all disks 116-124, it is desirable to enable the dynamic and invisible allocation of storage (e.g., disks) to each of the hosts 104-108 via the disk arrays 110, 112, 114. In other words, physical memory (e.g., physical disks) may be allocated through the concept of virtual memory (e.g., virtual disks). This allows one to connect heterogeneous initiators to a distributed, heterogeneous set of targets (storage pool) in a manner enabling the dynamic and transparent allocation of storage.

The concept of virtual memory has traditionally been used to enable physical memory to be virtualized through the translation between physical addresses in physical memory and virtual addresses in virtual memory. Recently, the concept of “virtualization” has been implemented in storage area networks through various mechanisms. Virtualization converts physical storage and virtual storage on a storage network. The hosts (initiators) see virtual disks as targets. The virtual disks represent available physical storage in a defined but somewhat flexible manner. Virtualization provides hosts with a representation of available physical storage that is not constrained by certain physical arrangements/allocation of the storage.

One early technique, Redundant Array of Independent Disks (RAID), provides some limited features of virtualization. Various RAID subtypes have been implemented. In RAID1, a virtual disk may correspond to two physical disks 116, 118 which both store the same data (or otherwise support recovery of the same data), thereby enabling redundancy to be supported within a storage area network. In RAID0, a single virtual disk is striped across multiple physical disks. Some other types of virtualization include concatenation, sparing, etc. Some aspects of virtualization have recently been achieved through implementing the virtualization function in various locations within the storage area network. Three such locations have gained some level of acceptance: virtualization in the hosts (e.g., 104-108), virtualization in the disk arrays or storage arrays (e.g., 110-114), and virtualization in a storage appliance 126 separate from the hosts and storage pool. Unfortunately, each of these implementation schemes has undesirable performance limitations.

Virtualization in the storage array is one of the most common storage virtualization solutions in use today. Through this approach, virtual volumes are created over the storage space of a specific storage subsystem (e.g., disk array). Creating virtual volumes at the storage subsystem level provides host independence, since virtualization of the storage pool is invisible to the hosts. In addition, virtualization at the storage system level enables optimization of memory access and therefore high performance. However, such a virtualization scheme typically will allow a uniform management structure only for a homogenous storage environment and even then only with limited flexibility. Further, since virtualization is performed at the storage subsystem level, the physical-virtual limitations set at the storage subsystem level are imposed on all hosts in the storage area network. Moreover, each storage subsystem (or disk array) is managed independently. Virtualization at the storage level therefore rarely allows a virtual volume to span over multiple storage subsystems (e.g., disk arrays), thus limiting the scalability of the storage-based approach.

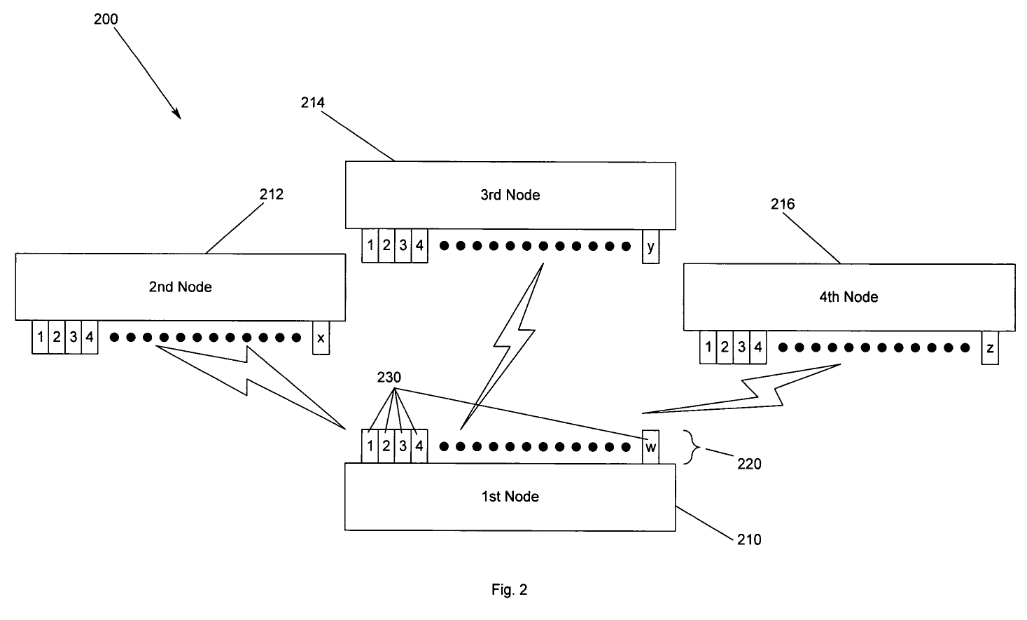

FIG. 2 shows wireless nodes in a wireless storage network 200 according to the present invention. In FIG. 2, a first node 210 communicates with the second 212, third 214 and fourth 216 nodes using a wireless communication protocol. For example, the wireless nodes 210-216 may communicate using WiFi (802.11x), Wireless Application Protocol (WAP), I-Mode, Bluetooth, General Packet Radio Services (GPRS), Time Division Multiple Access (TDMA), Code Division Multiple Access (CDMA), Global System For Mobile Communications (GSM), etc. Further, at least one of wireless nodes 210-216 may function as internetworking services that allow systems to communicate which could not otherwise. Typical internetworking services include relaying messages from one wireless node to another, resending messages from a wired LAN to a wireless node and resending messages from a wireless node to a wired LAN. The internetworking wireless node that provides such internetworking services functions as an Access Point or AP. The AP performs the full range of internetworking services and may have a wired network adapter as well as a wireless network adapter. Thus, a wireless node that provides internetworking services provides an interface between dissimilar communication protocols. However, for simplicity, it will be assumed in the following discussion that the first, second, third and fourth wireless storage nodes 210-216 operate using the same wireless protocol.

Any of the wireless nodes 210-216 may be a wireless storage node for providing broad-spectrum wireless access to storage. In one embodiment, a plurality of the wireless nodes 210-216 are configured as wireless storage nodes that include a wireless adapter 220 with one or more transceivers 230. Depending upon the design, the wireless adapters 220 may be configured to provide a large number of frequencies for communication with other wireless storage nodes. Each frequency is capable of transmitting a given bandwidth, X MB/sec. Each wireless storage node 210-216 may be designed to have only the number of frequency channels needed for the bandwidth associated with that wireless storage node. For example, a wireless switch in a storage area network may need many more frequency channels than a storage array because the switch must communicate, for example, with the storage array and at least one host or server.

As load requirements change between different wireless storage nodes 210-216, the number of paths will change rapidly, e.g., hundreds of times a second, between each wireless storage node to properly balance the load. The only limitation to the speed is the amount of bandwidth that can be transmitted over the allowed frequency range. One of the wireless nodes 210-216 may control the assignment of the frequency channels.

Referring to FIG. 2, a first wireless storage node 210 may have n frequencies at its disposal for communication with the second 212, third 214 and fourth 216 wireless storage nodes. Depending on the load requirements with the third 214 and fourth 216 wireless storage nodes, the first wireless storage node 212 may have additional frequency channels for communication with the second wireless storage node 212. Then, as load requirements change with respect to the third 214 and/or fourth 216 wireless storage node, the first wireless storage node 210 may reassign frequency channels to balance the loading between the first wireless storage node 210 and, for example, the second 212 and third 214 wireless storage node.

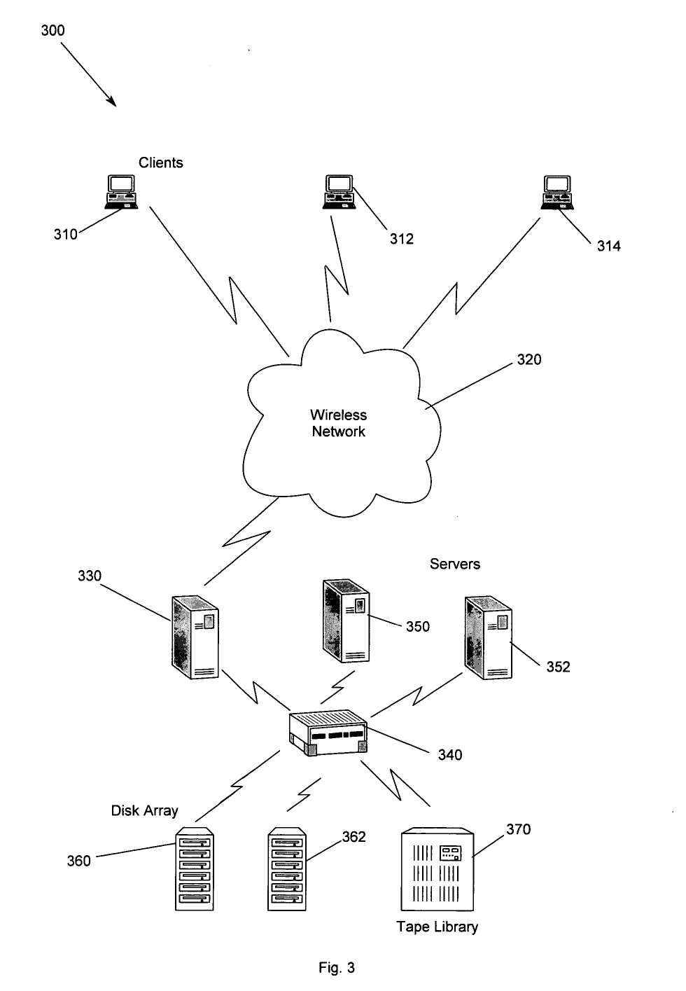

FIG. 3 shows a wireless storage network 300 according to an embodiment of the present invention. In FIG. 3, clients 310-314 are coupled to communicate wirelessly with a wireless network 320. Wireless network 320 is coupled to server 330. Server 330 is coupled to a switch 340 that provides wireless access to the other servers 350-352. Switch 340 provides wireless access to disk arrays 360-362 and to tape library 370.

Each element in FIG. 3 may act as a wireless storage node as described above. For example, switch 340 may have n frequencies at its disposal for communication with server 330 and with disk arrays 360-362 and tape library 370. Depending on the load requirements of the disk arrays 360-362 and tape library 370, the switch may assign additional frequency channels for communication with server 330. As load requirements with respect to disk arrays 360-362 and tape library 370 increase, the switch 340 may reassign frequency channels to balance the loading between the switch 340 and server 330, disk arrays 360-362 and tape library 370.

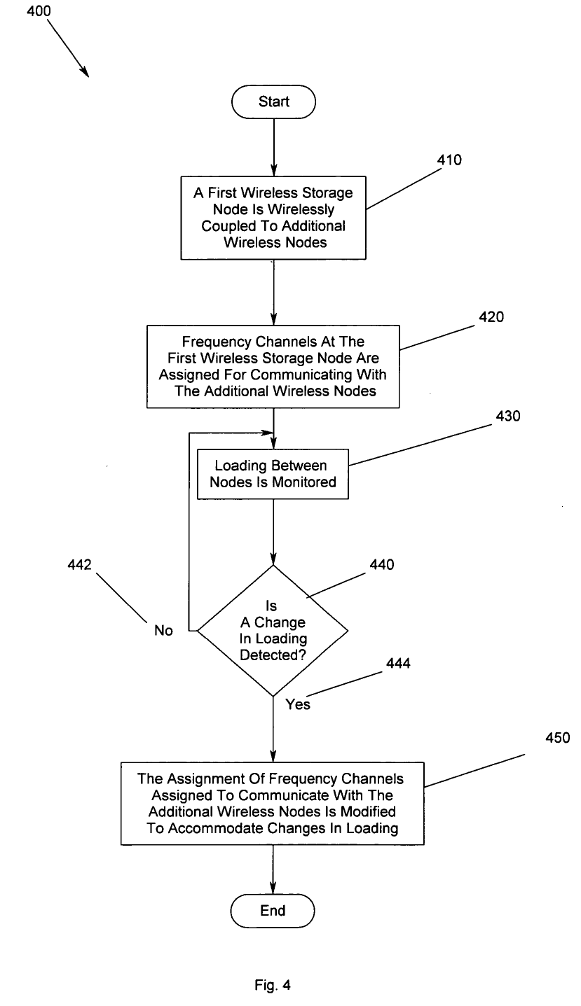

FIG. 4 is a flow chart 400 of the method for providing wireless storage according to an embodiment of the present invention. A first wireless storage node is wirelessly coupled to additional wireless storage nodes 410. Frequency channels at the first wireless storage node are assigned for communicating with the additional wireless storage nodes 420. The loading between nodes is monitored 430. A determination is made whether a loading change occurs 440. If not 442, the loading between nodes continues to be monitored. If the loading changes 444, the assignment of frequency channels assigned with communicating with the additional wireless storage nodes is modified 450.

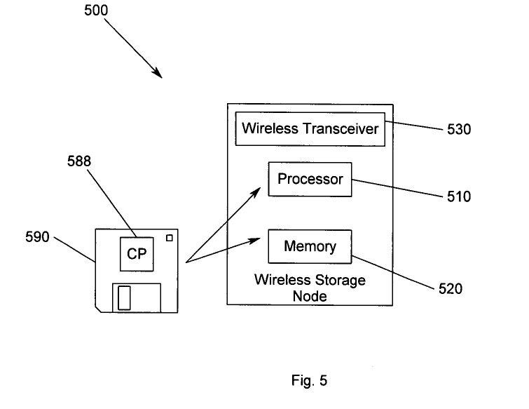

FIG. 5 illustrates a wireless storage node 500 according to an embodiment of the present invention. In FIG. 5, a wireless storage node 500 is shown to include a processor 510 and memory 520. The processor controls and processes data for the transceiver 530. The process illustrated with reference to FIGS. 1-4 may be tangibly embodied in a computer-readable medium or carrier, e.g. one or more of the fixed and/or removable data storage devices 588 illustrated in FIG. 5, or other data storage or data communications devices. The computer program 590 may be loaded into memory 520 to configure the processor 510 for execution. The computer program 590 include instructions which, when read and executed by a processor 510 of FIG. 5 causes the processor 510 to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. A wireless storage network, comprising:
a first wireless storage node;
a network node; and
a plurality of wireless channels coupling the first wireless storage node and the network node, an assignment of the plurality of the wireless channels of the first wireless storage node being based upon loading.

2. The wireless storage network of claim 1, wherein the network node comprises a second wireless node.

3. The wireless storage network of claim 1, wherein the loading comprises system loading.

4. The wireless storage network of claim 1, wherein the loading comprises loading of the first wireless storage node.

5. The wireless storage network of claim 1, wherein the first wireless storage node is assigned a first number of the wireless channels to provide a first bandwidth.

6. The wireless storage network of claim 5, wherein, upon a load change, the first wireless storage node is assigned a second number of the wireless channels to provide a second bandwidth.

7. A method for providing wireless storage, comprising:
assigning a first set of wireless channels to a first wireless storage node;
assigning a second set of wireless channels to a wireless network node;
monitoring a loading between the wireless network node and at least the first wireless storage node; and
modifying the assignment of wireless channels when the loading between the wireless network node and at least the first wireless storage node changes.

8. The method of claim 1, wherein the monitoring a loading comprises monitoring a system loading.

9. The method of claim 1, wherein the monitoring a loading comprises monitoring loading of the first wireless storage node.

10. The method of claim 1, wherein the modifying the assignment of wireless channels comprises assigning additional wireless channels to the first wireless storage node when a larger bandwidth is needed.

11. The method of claim 1, wherein the modifying the assignment of wireless channels comprises reducing the number of wireless channels to the first wireless storage node when the wireless network node needs more bandwidth to communicate with a second wireless storage node.

12. The method of claim 1, wherein the assigning a second set of wireless channels to a wireless network node further comprises assigning a second set of wireless channels to a wireless storage node.

13. A wireless storage network, comprising:
a plurality of wireless storage devices having at least one wireless interface each; and
a plurality of wireless channels, the wireless channels being assigned to the wireless interfaces of the plurality of wireless storage devices;
wherein the load to the plurality of wireless storage devices is balanced by adjusting assignments of the plurality of wireless channels to the plurality of wireless storage devices.

14. The wireless storage network of claim 13 further comprising at least one wireless network device for controlling the assignment of wireless storage devices.

15. The wireless storage network of claim 13, wherein the loading comprises system loading.

16. The wireless storage network of claim 13, wherein the loading comprises loading of a wireless storage device.

17. The wireless storage network of claim 13, wherein a first wireless storage node is assigned a first number of the wireless channels to provide a first bandwidth.

18. The wireless storage network of claim 17, wherein, upon a load change, the first wireless storage node is assigned a second number of the wireless channels to provide a second bandwidth.

19. A program storage device readable by a computer tangibly embodying one or more programs of instructions executable by the computer to perform a method for providing wireless storage, the method comprising:
assigning a first set of wireless channels to a first wireless storage node;
assigning a second set of wireless channels to a wireless network node;
monitoring a loading between the wireless network node and at least the first wireless storage node; and
modifying the assignment of wireless channels when the loading between the wireless network node and at least the first wireless storage node changes.

20. The program storage device of claim 19, wherein the monitoring a loading comprises monitoring a system loading.

21. The program storage device of claim 19, wherein the monitoring a loading comprises monitoring loading of the first wireless storage node.

22. The program storage device of claim 19, wherein the modifying the assignment of wireless channels comprises assigning additional wireless channels to the first wireless storage node when a larger bandwidth is needed.

23. The program storage device of claim 19, wherein the modifying the assignment of wireless channels comprises reducing the number of wireless channels to the first wireless storage node when the wireless network node needs more bandwidth to communicate with a second wireless storage node.

24. The program storage device of claim 19, wherein the assigning a second set of wireless channels to a wireless network node further comprises assigning a second set of wireless channels to a wireless storage node.
